(19) United States
(12) Patent Application Publication
(10) Pub. No.: US 2015/0262148 A1
(43) Pub. Date: Sep. 17, 2015

(54) SYSTEMS AND METHODS FOR SERVICE REQUEST PROCESSING

(71) Applicant: Bank of America Corporation, Charlotte, NC (US)

(72) Inventors: Michelle D. Nichols, Charlotte, NC (US); Debbie J. Adams, Charlotte, NC (US); David Bohn, Chicago, IL (US); Jeffrey R. Goertz, Kansas City, MO (US); Janice A. Melanson, Willmington, MA (US); John E. Scully, Chicago, IL (US); Ken L. Snellings, Charlotte, NC (US); Billy Scott Tapp, Scurry, TX (US)

(73) Assignee: Bank of America Corporation, Charlotte, NC (US)

(21) Appl. No.: 14/203,660

(22) Filed: Mar. 11, 2014

(51) Int. Cl. G06Q 20/10; G06Q 20/40; G06Q 20/04

(52) U.S. Cl. CPC G06Q 20/108; G06Q 20/042; G06Q 20/4016

(57) ABSTRACT

Apparatus for executing a method to determine whether or not a service request is eligible for straight through processing is provided. The apparatus may receive a service request from an online banking portal. The service request may include an adjustment value. The adjustment value may be a numerical difference between a first value of a check deposited in a customer account and a second value of a check entered into the online banking portal. The service request may also include a time of day during which the service request was requested and/or completed. The apparatus may determine if the adjustment value is less than a threshold value. If the adjustment value is less than the threshold value, the apparatus may transmit the service request to a straight through processing platform and to electronically display on the online banking portal a soft post notifying a user of a credit.

### FIELD OF TECHNOLOGY

The invention relates to systems and methods for processing a service request. Specifically, the invention relates to systems and methods for using metadata to process a service request.

### BACKGROUND OF THE DISCLOSURE

Online banking has become a popular form of banking for many individuals and businesses. When a user interacts with his online banking account, he may have one or more questions regarding displayed information. An online banking portal may enable the user to create an electronic message, or ‘service request.’ The service request typically includes the user's question(s) and any attendant requests, and is transmitted to the bank for processing.

Processing service requests is both time consuming and costly. It would be desirable, therefore, to provide systems and methods for enabling a business to quickly and efficiently process service requests. This would be desirable at least because it can assist the bank in increasing customer satisfaction and minimizing costs.

### SUMMARY OF THE DISCLOSURE

Systems and methods are provided for determining whether or not a service request is eligible for straight through processing. The methods may include receiving a service request from an online banking portal. The service request may include an adjustment value. The adjustment value may be a numerical difference between a first value of a check deposited in a customer account and a second value of a check entered into the online banking portal. The service request may also include a time of day during which the service request was requested and/or completed. The method may further include determining if the adjustment value is less than a threshold value. When the adjustment value is less than the threshold value, the method may further include transmitting the service request to a straight through processing platform and electronically displaying on the online banking portal a soft post notifying a user of a credit to the customer account. The credit may be equal in value to the adjustment value. The soft post may be displayed on the online banking portal after a predetermined time period has lapsed from the time of day during which the service request was requested and/or completed.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with the principles of the invention;

FIG. 2 shows another illustrative apparatus in accordance with the principles of the invention;

FIG. 3 shows illustrative steps of a process in accordance with the principles of the invention;

FIG. 4 shows illustrative steps of a process in accordance with the principles of the invention;

FIG. 5 shows illustrative steps of a process in accordance with the principles of the invention;

FIG. 6 shows illustrative steps of a process in accordance with the principles of the invention; and

FIG. 7 shows illustrative steps of a process in accordance with the principles of the invention.

### DETAILED DESCRIPTION OF THE DISCLOSURE

Apparatus and methods of the invention relate to processing service requests. The apparatus may include a computer system that may perform one or more of the methods. The method(s) may be performed to determine whether or not a service request is eligible for straight through processing.

The methods may include receiving a service request. The service request may be submitted by a user. The user may maintain a customer account. The service request may be associated with the account. The service request may be generated at an online banking portal. The service request may be received from the online banking portal.

The service request may include a time of day during which the service request was requested and/or completed. The service request may include a time of day during which the service request was submitted. The service request may include a time of day during which the service request was received.

The service request may include an account adjustment amount (alternatively, “adjustment value”). The account adjustment amount may include a numerical difference between a first value of a transaction transacted on the account and a second value of a transaction transacted on the account entered into the online banking portal or another online banking portal. The account adjustment amount may include a numerical difference between a first value of a check deposited in the account and a second value of a check entered into the online banking portal or another online banking portal. The account adjustment amount may include a numerical difference between a first value of a debit withdrawal from the account and a second value of a debit withdrawal entered into the online banking portal or another online banking portal.

The service request may include a check number correction. The check number correction may include a request from a customer to change the check number, or other identifying information, associated with a deposited check. For example, a financial institution may have recorded that a deposited check was identified by the check number “1426” when in fact the customer's records indicate that the correct check number was “1427.” In such a case, the request will request that the deposit records show that the check number is 1427. As such, the financial institution may make a debit corresponding to the amount associated with check number 1426 to correct the credit previously associated with 1426 and then show the same credit associated with check number 1427.

The service request may include metadata. The metadata may be associated with the account.

The metadata may include a customer account type. The metadata may include permissions submitted, or submittable, by the user when accessing the account. The account metadata may include permissions used in accessing the account.

In some embodiments, the risk level may be based on services associated with the account such as reconciliation services, account preferences or any other suitable services or parameters associated with the account.

The metadata may include a domicile region of the account. The domicile region may include, but is not limited to, a country, a state, or a region of a country.

The metadata may include customer navigation history. The navigation history may be executed, via the online banking portal or via other online banking portals, prior to submission of the service request.

The metadata may include a number of service requests, which may include adjustment amounts, generated during a predetermined timed period. The account metadata may also include a sum total of adjustment amounts which may be included in one or more service requests. The one or more service requests may be generated during a predetermined time period.

The methods may include determining, based at least in part on the metadata, if the service request qualifies for straight through processing. The methods may include determining if the account adjustment amount is less than a first threshold value. The first threshold value may be determined. The first threshold value may be retrieved.

The first threshold value may be associated with the metadata. The first threshold value may be associated with the domicile region. The first threshold value may be associated with the customer account type. The first threshold value may be associated with the navigation history. The first threshold value may be associated with the number of service reports. The first threshold value may be associated with the sum total of adjustment amounts.

If the account adjustment amount is less than the first threshold value, the service request may qualify for straight through processing.

The methods may include determining, based at least in part on the metadata, a risk level associated with the account. The methods may further include determining if the risk level is less than a second threshold value. The second threshold value may be determined. The second threshold value may be retrieved.

The second threshold value may be associated with the metadata. The second threshold value may be associated with the domicile region. The second threshold value may be associated with the customer account type. The second threshold value may be associated with the navigation history. The second threshold value may be associated with the number of service reports. The second threshold value may be associated with the sum total of adjustment amounts.

When the account adjustment amount is less than the first threshold value, and the risk level is less than the second threshold value, the methods may include transmitting the service request to a straight through processing platform.

If the account adjustment amount is equal to or greater than the first threshold value, or if the risk level is equal to or greater than the second threshold value, the method may include routing, or otherwise transmitting, the service request for handling by a customer representative.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, the embodiments may be embodied as a method, a data processing system, or a computer program product. Accordingly, the embodiments may take the form of an entirely hardware embodiment, an entirely software embodiment or an embodiment combining software and hardware aspects.

Furthermore, embodiments may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Exemplary embodiments may be embodied at least partially in hardware and include one or more databases, receivers, transmitters, processors, modules including hardware and/or any other suitable hardware. Furthermore, operations executed may be performed by the one or more databases, receivers, transmitters, processors and/or modules including hardware.

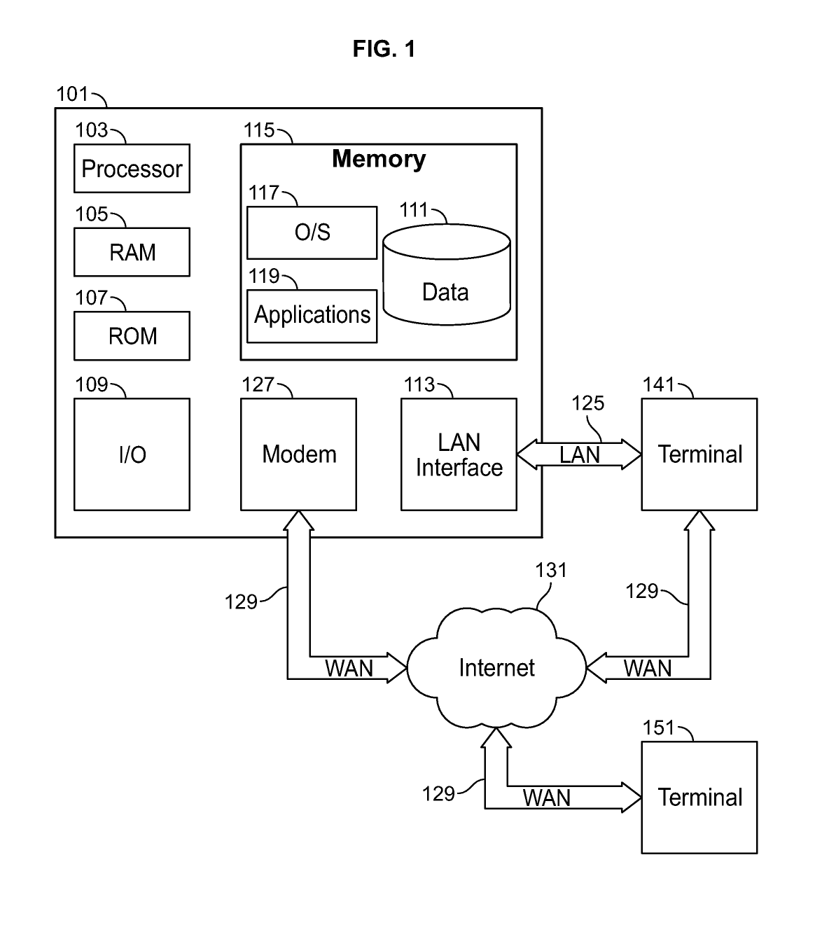

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for information input into one or more of the database(s) described herein, the parameters for straight through processing, account metadata, the service requests, the account adjustment thresholds, domicile information, etc.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of the embodiments set forth herein. Information input may be stored in memory 115. The input information may be processed by an application such as one of applications 119.

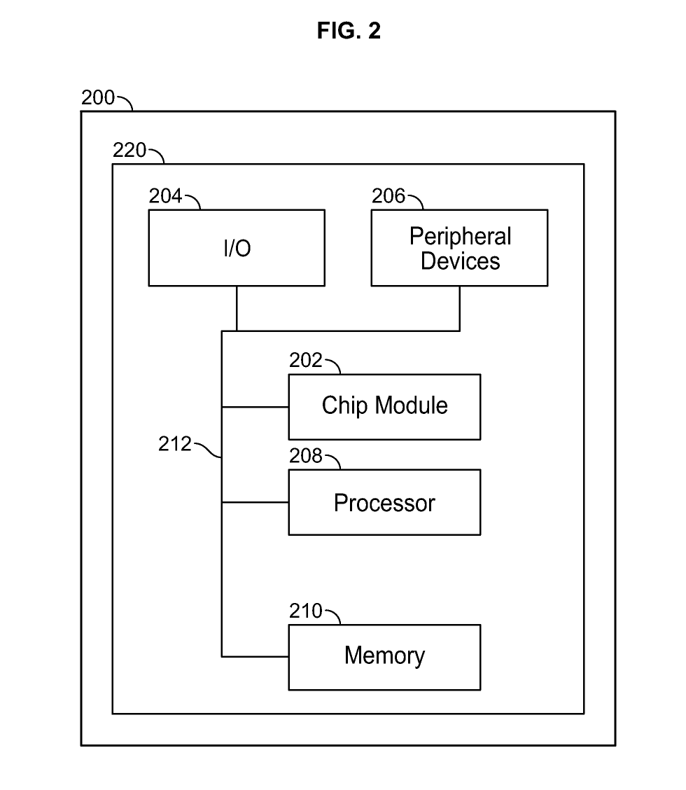

FIG. 2 shows an illustrative apparatus that may be configured in accordance with the principles of the invention.

FIG. 2 shows illustrative apparatus 200. Apparatus 200 may be a computing machine. Apparatus 200 may be included in apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include the transmitter device and the receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device (“processor”) 208, which may compute data structural information, structural parameters of the data, quantify indicies; and machine-readable memory 210.

Machine-readable memory 210 may be configured to store in machine-readable data structures: data lineage information; data lineage, technical data elements; data elements; business elements; identifiers; associations; relationships; and any other suitable information or data structures.

Components 202, 204, 206, 208 and 210 may be coupled together by a system bus or other interconnections 212 and may be present on one or more circuit boards such as 220. In some embodiments, the components may be integrated into a single silicon-based chip.

It will be appreciated that software components including programs and data may, if desired, be implemented in ROM (read only memory) form, including CD-ROMs, EPROMs and EEPROMs, or may be stored in any other suitable computer-readable medium such as but not limited to discs of various kinds, cards of various kinds and RAMs. Components described herein as software may, alternatively and/or additionally, be implemented wholly or partly in hardware, if desired, using conventional techniques.

Various signals representing information described herein may be transferred between a source and a destination in the form of electromagnetic waves traveling through signal-conducting encoded media such as metal wires, optical fibers, and/or wireless transmission encoded media (e.g., air and/or space).

Apparatus 200 may operate in a networked environment supporting connections to one or more remote computers via a local area network (LAN), a wide area network (WAN), or other suitable networks. When used in a LAN networking environment, apparatus 200 may be connected to the LAN through a network interface or adapter in I/O circuitry 204. When used in a WAN networking environment, apparatus 200 may include a modem or other means for establishing communications over the WAN. It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to operate processor 208, for example over the Internet.

Apparatus 200 may be included in numerous general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, tablets, programmable consumer electronics, network PCs, minicomputers, mainframe computers, distributed computing environments that include any of the above systems or devices, and the like.

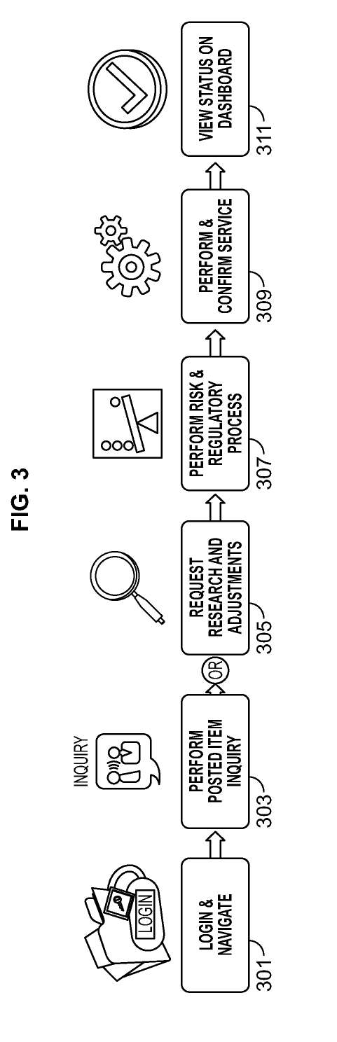

FIGS. 3-7 illustrate exemplary processes that may be used in accordance with the systems and methods of the invention. It should be noted that the exemplary processes illustrated in FIGS. 3-7 are for illustrative purposes only. Each of the steps included in FIGS. 3-7 are optional, and may be deleted, modified, and/or generated in an order different from the order illustrated. Furthermore, one or more steps not illustrated in FIGS. 3-7, but described herein, may be added to the processes detailed in FIGS. 3-7.

Additionally, it should be noted that each of the steps illustrated in FIGS. 3-7 may be executed by one or more receivers, transmitters, processors, and/or any other suitable hardware or software.

FIG. 3 shows an illustrative process in accordance with the invention. The illustrative process in FIG. 3 may include one or more of steps 301-311.

At step 301, a user may login and navigate an online banking account. At step 303, a user may perform a posted item inquiry. The posted item inquiry may relate to a display posted on the online banking account. The posted item inquiry may relate to a check, debit, or credit amount, a cancelled check, or a check number that was debited twice.

At step 305, the user may request research and adjustments. The user may request the research and adjustments by generating a service request. The user may generate the service request by entering one or more pieces of data into input fields included in the service request.

At step 307, the financial institution may perform a risk and regulatory process. The risk and regulatory service may analyze the service request and/or one or more pieces of metadata associated with the service request. The risk and regulatory process may identify a preferred method for processing the service request. The preferred method may include straight through processing, or transmitting the service request to an agent desktop workstation. At step 309, the financial institution may perform necessary actions, such as responding to the service request, and confirm status. The response and confirmation of status may include confirming the preferred method identified in step 307. At step 311, the customer may view the status of his service request on the dashboard.

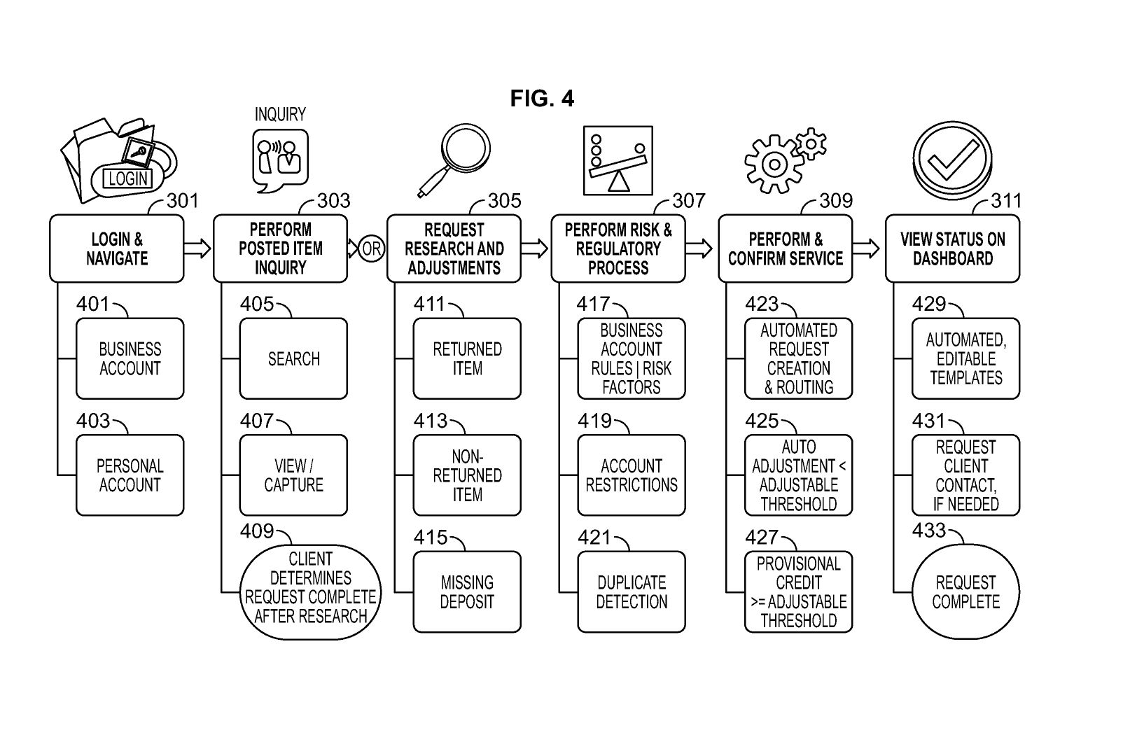

FIG. 4 shows an illustrative process in accordance with the invention. The illustrative process in FIG. 4 may include one or more of steps 301-311 and 401-433.

At step 301, a user may login and navigate an online banking account. The user may access business account 401 or personal account 403.

At step 303, a user may perform a posted item inquiry. The user may perform the posted item inquiry by search 405. Search 405 may include the user searching for a particular withdrawal or deposit, and subsequently having a question regarding the withdrawal or deposit. The user may also perform posted item inquiry by view/capture 407. View/Capture 407 may include the user viewing a posted withdrawal or deposit, and subsequently having a question regarding the withdrawal or deposit.

The user may subsequently determine request complete after research 409. As such, the user may not generate a service request related to his previous question. However, at step 305, the user may instead request research and adjustment(s). The requested research and adjustments may be in relation to returned item 411, non-returned item 413, missing deposit 415, and any other suitable deposit or withdrawal.

At step 307, the financial institution may perform a risk and regulatory process. The risk and regulatory process may include a plurality of decisional factors such as business account rules/risk factors 417, account restrictions 419, and duplicate detection 421. The decisional factors may be used to identify a preferred method for processing the service request. The preferred method may include straight through processing, or transmitting the service request to an agent desk top.

At step 309, the financial institution may perform and confirm status. The performance and confirmation of status may include confirming the preferred method identified in step 307. An example of a preferred method includes automated request creation and routing 423. Alternately, or additionally, the performance and confirmation of status may include applying additional decisional factors to determine how to process the service request. Additional decisional factors may include auto adjustment <adjustable threshold 425 and provisional credit >=adjustable threshold 427.

At step 311, the customer may view the status of his service request on the dashboard. The status of the service request may include one or more of automated, editable templates 429 and/or request client contact, if needed 431.

At step 433, the customer's request may be completed.

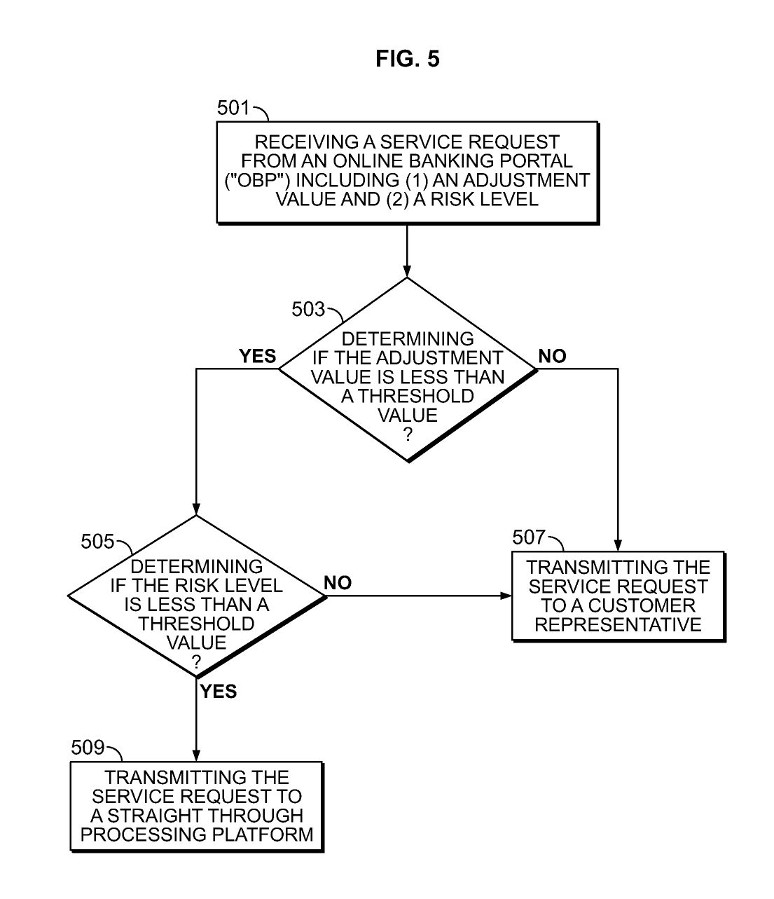

FIG. 5 shows an illustrative process in accordance with the invention. The illustrative process in FIG. 5 may include one or more of steps 501-509.

The process illustrated in FIG. 5, at step 501, may include receiving a service request from an online banking portal (“OBP”). The service request may include at least (1) an adjustment value and (2) a risk level.

At step 503, the process may include determining if the adjustment value is less than a threshold value. If the adjustment value is greater than the threshold value, the process may continue at step 507. At step 507, the process may include transmitting the service request to a customer service representative.

If the adjustment value is less than the threshold value, the process may continue at step 505. At step 505, the process may include determining if the risk level is less than a threshold value.

If the risk level is greater than the threshold value, the process may continue at step 507. At step 507, the process may include transmitting the service request to a customer service representative. If the risk level is less than the threshold value, the process may continue at step 509. At step 509, the process may include transmitting the service request to a straight through processing platform.

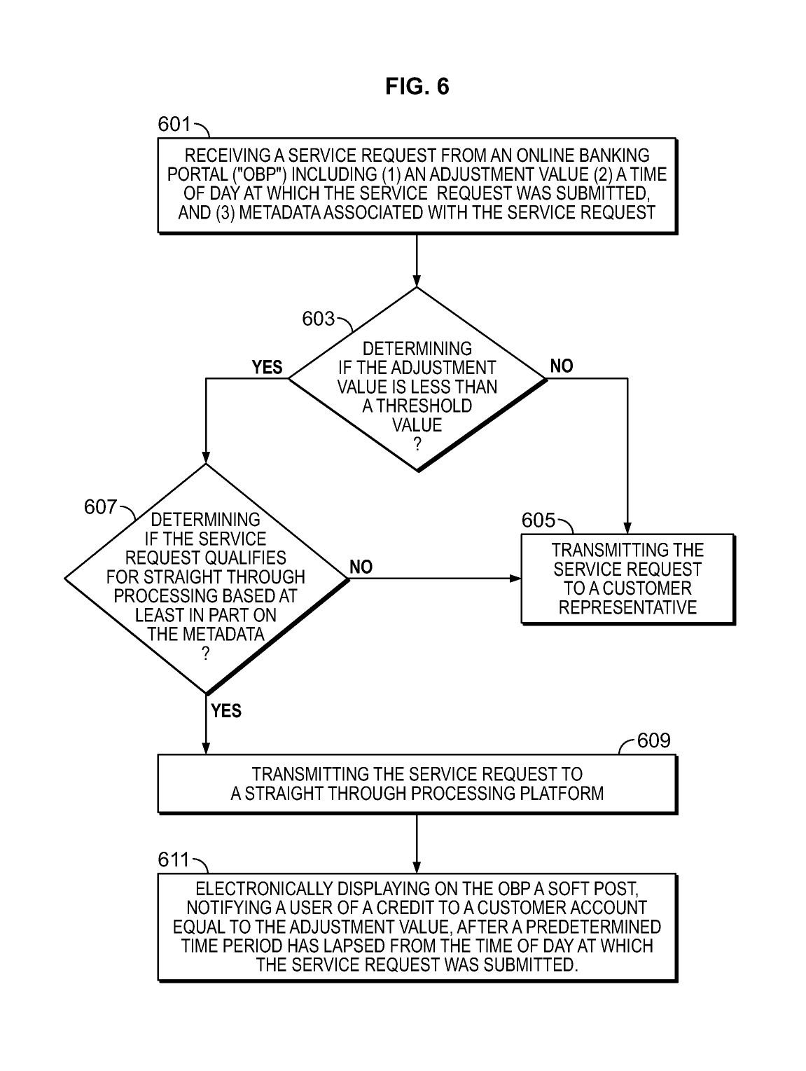

FIG. 6 shows an illustrative process in accordance with the invention. The illustrative process in FIG. 6 may include one or more of steps 601-611.

The process illustrated in FIG. 6, at step 601, may include receiving a service request from an online banking portal (“OBP”). The service request may include at least (1) an adjustment value, (2) a time of day at which the service request was submitted, and (3) metadata associated with the service request.

The process may continue at step 603. At step 603, the process may include determining if the adjustment value is less than a threshold value. If the adjustment value is greater than the threshold value, the process may continue at step 605. At step 605, the process may include transmitting the service request to a customer representative.

If the adjustment value is less than the threshold value, the process may continue at step 607. At step 607, the process may include determining if the service request qualifies for straight through processing based at least in part on the metadata. If the service request does not qualify for straight through processing, the process may continue at step 605.

If the service request does qualify for straight through processing, the process may continue at step 609. At step 609, the process may include transmitting the service request to a straight through processing platform. At step 611, the process may include electronically displaying on the OBP a “soft post.” The soft post, which may alternatively be referred to as a memo post, may notify a user of an expected credit to a customer account. The credit may be equal to the adjustment value. The soft post may be displayed after a predetermined time period has lapsed from the time of day at which the service request was submitted.

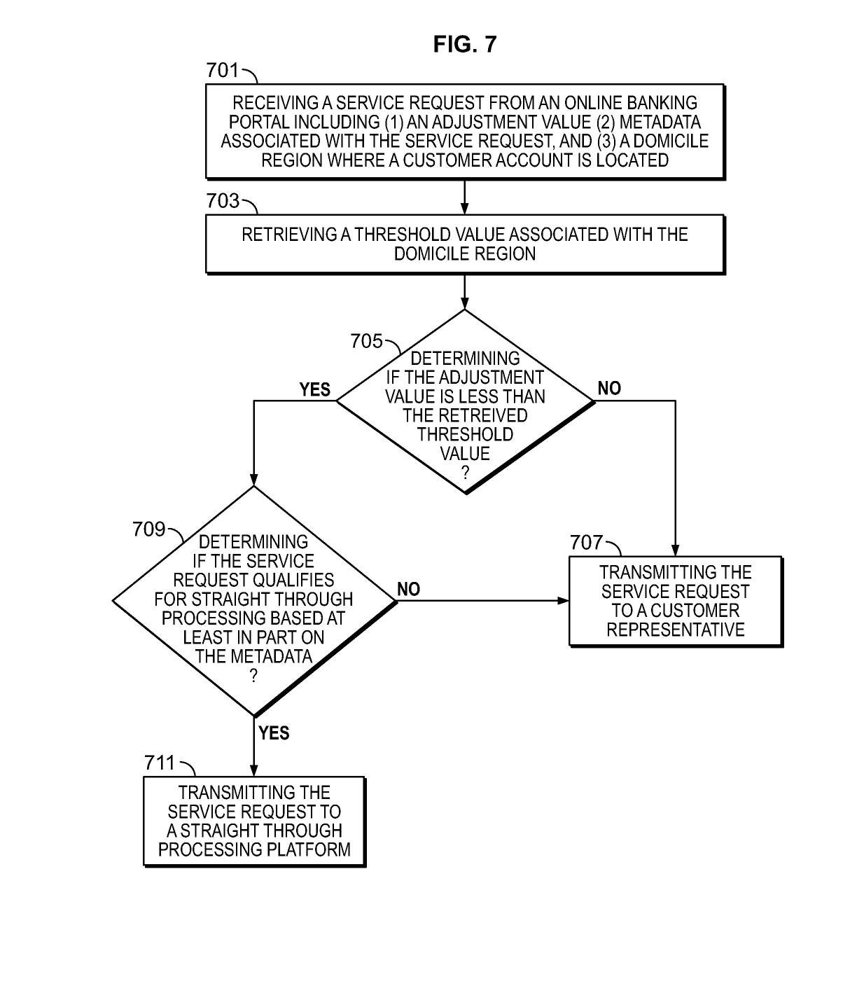

FIG. 7 shows an illustrative process in accordance with the invention. The illustrative process in FIG. 7 may include one or more of steps 701-711.

At step 701, the process may include receiving a service request from an online banking portal. The service request may include at least (1) an adjustment value, (2) metadata associated with the service request, and (3) a domicile region where a customer account is located.

The process may continue at step 703. At step 703, the process may include retrieving a threshold value associated with the domicile region. At step 705, the process may include determining if the adjustment value is less than the retrieved threshold value. If the adjustment value is greater than the retrieved threshold value, the process may continue at step 707. At step 707, the process may include transmitting the service request to a customer representative.

If the adjustment value is less than the retrieved threshold value, the process may continue at step 709. At step 709, the process may include determining if the service request qualifies for straight through processing based at least in part on the metadata. If the service request does not qualify for straight through processing, the process may continue at step 707. If the service request does qualify for straight through processing, the process may continue at step 711. At step 711, the process may include transmitting the service request to a straight through processing platform.

Thus, methods and apparatus for processing a service request based at least in part on metadata associated with the service request have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. An article of manufacture comprising a non-transitory computer usable medium having computer readable program code embodied therein, the code when executed by one or more processors configuring a computer to execute a method to determine whether or not a service request is eligible for straight through processing, the method comprising:
receiving a service request from an online banking portal, the service request including:
an adjustment value, the adjustment value being a numerical difference between a first value of a check deposited in a customer account and a second value of a check entered into the online banking portal; and
a risk level associated with the customer account;
determining if the adjustment value is less than a first threshold value;
if the adjustment value is less than the first threshold value, determining if the risk level is less than a second threshold value;
if the risk level is less than the second threshold value, transmitting the service request to a straight through processing platform; and
if the adjustment value is equal to or greater than the first threshold value, or if the risk level is equal to or greater than the second threshold value, transmitting the service request to a workstation associated with a customer representative.

2. The article of claim 1 wherein, in the method, the service request further comprises metadata, the metadata further comprising customer navigation history executed in the online banking portal prior to submission of the service request.

3. The article of claim 1 wherein, in the method, the risk level is based at least in part on a domicile region of the customer account.

4. The article of claim 1 wherein, in the method, the risk level is based at least in part on a customer account type.

5. The article of claim 2 wherein, in the method, the metadata further include a number of service requests generated during a predetermined time period, the service requests including adjustment values.

6. The article of claim 2 wherein, in the method, the metadata further include a sum total of adjustment values included in one or more service requests, the one or more service requests being generated during a predetermined time period.

7. The article of claim 2 wherein, in the method, the metadata further include permissions of a user accessing the account.

8. An article of manufacture comprising a non-transitory computer usable medium having computer readable program code embodied therein, the code when executed by one or more processors configuring a computer to execute a method to determine whether or not a service request is eligible for straight through processing, the method comprising:
receiving a service request from an online banking portal, wherein the service request includes:
an account adjustment amount; and
account metadata;
determining a risk level associated with the account based at least in part on the account metadata;
determining if the account adjustment amount is less than a first threshold value;
determining if the risk level is less than a second threshold value;
if the account adjustment amount is less than the first threshold value, and the risk level is less than the second threshold value, transmitting the service request to a straight through processing platform; and
if the account adjustment amount is equal to or greater than the first threshold value, or if the risk level is equal to or greater than the second threshold value, transmitting the service request to a customer representative.

9. The article of claim 8 wherein, in the method, the account metadata comprise customer navigation history executed in the online banking portal prior to submission of the service request.

10. The article of claim 8 wherein, in the method, the account metadata comprise a domicile region of the customer account.

11. The article of claim 8 wherein, in the method, the account metadata comprise a customer account type.

12. The article of claim 8 wherein, in the method, the account metadata comprise a number of service requests generated during a predetermined time period, the service requests including adjustment values.

13. The article of claim 8 wherein, in the method, the account metadata comprise a sum total of adjustment values included in one or more service requests, the one or more service requests being generated during a predetermined time period.

14. The article of claim 8 wherein, in the method, the account metadata comprise permissions of a user accessing the account.

15. The article of claim 8 wherein, in the method, the account adjustment amount is a numerical difference between a first value of a check deposited in a customer account and a second value of a check entered into the online banking portal.

16. The article of claim 8 wherein, in the method, the account adjustment amount is a numerical difference between a first value of a debit withdrawal from a customer account and a second value of a debit withdrawal entered into the online banking portal.

17. An article of manufacture comprising a non-transitory computer usable medium having computer readable program code embodied therein, the code when executed by one or more processors configuring a computer to execute a method to determine whether or not a service request is eligible for straight through processing, the method comprising:
receiving a service request from an online banking portal, the service request including:
an check number correction, the check number correction being a numerical difference between a first check number deposited in a customer account and a second check number entered into the online banking portal; and
metadata comprising a risk level associated with the customer account;
determining if an amount of the check is less than a first threshold value;
if the adjustment value is less than a first threshold value, determining if the risk level is less than a second threshold value;
if the risk level is less than the second threshold value, transmitting the service request to a straight through processing platform; and
if the adjustment value is equal to or greater than the first threshold value, or if the risk level is equal to or greater than the second threshold value, transmitting the service request to a workstation associated with a customer representative.

18. The article of claim 17 wherein, in the method, the metadata further comprise customer navigation history executed in the online banking portal prior to submission of the service request.

19. The article of claim 17 wherein, in the method, the risk level is based at least in part on a domicile region of the customer account.

20. The article of claim 17 wherein, in the method, the risk level is based at least in part on a customer account type.

21. The article of claim 17 wherein, in the method, the metadata further include permissions of a user accessing the account.
